(19) United States
(12) Patent Application Publication
(10) Pub. No.: US 2002/0155340 A1
(43) Pub. Date: Oct. 24, 2002

(54) Membrane electrode assembly and method for producing same, and polymer electrolyte fuel cell comprising such membrane electrode assemblies

(75) Inventors: Masaaki Nanaumi, Saitama-ken (JP); Hiroshi Sohma, Saitama-ken (JP); Junji Matsuo, Saitama-ken (JP); Nobuhiro Saito, Saitama-ken (JP); Keisuke Andou, Saitama-ken (JP); Yuichiro Sugiyama, Saitama-ken (JP); Kaoru Fukuda, Saitama-ken (JP)

Correspondence Address: SUGHRUE MION, PLLC, 2100 Pennsylvania Avenue, NW, Washington, DC, 20037-3213, US

(73) Assignee: HONDA GIKEN KOGYO KABUSHIKI KAISHA

(21) Appl. No.: 10/050,518

(22) Filed: Jan. 18, 2002

(30) Foreign Application Priority Data
Jan. 19, 2001 (JP) 2001-12491
Jan. 19, 2001 (JP) 2001-12493

(51) Int. Cl. H01M 8/10

(52) U.S. Cl. 429/40; 429/41; 429/42; 429/46

(57) ABSTRACT

The membrane electrode assembly comprising a pair of opposing electrodes each having a catalytic layer, and a polymer electrolyte membrane sandwiched by the electrodes, part of the catalytic layers being projecting into the polymer electrolyte membrane is produced by (1) coating a catalytic layer of one electrode with a solution of a polymer electrolyte in an organic solvent, (2) coating the resultant polymer electrolyte membrane with a catalyst slurry for the other electrode, while the amount of the organic solvent remaining in the polymer electrolyte membrane is 5-20 weight % based on the polymer electrolyte membrane, and (3) after drying, hot-pressing the polymer electrolyte membrane and the electrodes formed on both sides of the membrane.

### FIELD OF THE INVENTION

The present invention relates to a membrane electrode assembly for a polymer electrolyte fuel cell capable of being subjected to low-humidifying operation, and a method for producing such a membrane electrode assembly, and a polymer electrolyte fuel cell comprising such a membrane electrode assembly. The present invention also relates to a membrane electrode assembly comprising a polymer electrolyte membrane having improved heat resistance without suffering from deterioration of power-generating performance, and a method for producing such a membrane electrode assembly and a polymer electrolyte fuel cell comprising it.

### BACKGROUND OF THE INVENTION

As the depletion of oil resources, global warming, etc. have been becoming serious environmental problems, much attention has been paid to fuel cells as clean power sources for motors, and wide development is now carried out to put them into practical use. Particularly when fuel cells are mounted in automobiles, etc., they are preferably polymer electrolyte fuel cells for the purpose of reduction in weight. Widely used as polymer electrolyte membranes are ion exchange membranes of sulfonated, fluorinated resins such as Nafion® (available from du Pont) and Flemion® (available from Asahi Glass Co., Ltd.).

In the polymer electrolyte fuel cell, a polymer electrolyte membrane and both catalytic layers of electrodes should be moist to suppress decrease in ion conductivity. For this purpose, a fully humidified fuel is generally supplied to a fuel electrode. However, considering the miniaturization of a fuel cell, it is preferable to put the fuel in a low or no humidification state.

In the polymer electrolyte fuel cell, protons move with water through the polymer electrolyte membrane from the fuel electrode to the oxygen electrode. Accordingly, the fuel electrode is likely to be dried, resulting in likelihood of reduction in proton conductivity. On the other hand, if water is excessively generated in the oxygen electrode, a flooding phenomenon (a phenomenon of closing the diffusion path of a gas by wetting the catalytic layer) occurs by the electrode reaction. Thus, water should be supplemented in the fuel electrode, while water should be removed in the oxygen electrode.

Proposed for such water control are (a) a method for humidifying a polymer electrolyte membrane via twisted threads embedded therein, or (b) a method in which a water absorbent is added to the electrodes (Japanese Patent Laid-Open No. 10-334922). However, the method (a) suffers from the problem that the polymer electrolyte membrane has a large thickness by sandwiching the threads, resulting in decrease in ion conductivity, and the method (b) suffers from the problem that the addition of the water absorbent lowers the ion exchange capacity of the electrodes.

A membrane electrode assembly for a polymer electrolyte fuel cell comprising a polymer electrolyte membrane is produced by hot-pressing the polymer electrolyte membrane and electrodes at higher temperatures than the softening point of the polymer electrolyte membrane. Because there is a large contact area between a catalytic layer of each electrode and the polymer electrolyte membrane in the membrane electrode assembly produced by hot-pressing, a fuel cell comprising such membrane electrode assembly is advantageous in having a high power-generating performance.

However, because there is increasing demand to provide fuel cells with higher power, a polymer electrolyte membrane having such a high heat resistance as to make it possible to endure high-temperature operation has become needed. Because the polymer electrolyte membrane having a high heat resistance has a high softening point, it should be hot-pressed at higher temperatures than for the conventional membranes. In this case, however, part of a polymer structure of the polymer electrolyte is thermally decomposed, resulting in the deterioration of power-generating performance of the fuel cells.

### OBJECTS OF THE INVENTION

Accordingly, an object of the present invention is to provide a membrane electrode assembly for a polymer electrolyte fuel cell capable of achieving low-humidifying operation without increasing a membrane thickness and decreasing an ion exchange capacity, etc., and a method for producing it, as well as a polymer electrolyte fuel cell comprising such membrane electrode assemblies.

Another object of the present invention is to provide a membrane electrode assembly comprising a polymer electrolyte membrane having not only a high power-generating performance but also such a high heat resistance that it is not decomposed by high-temperature hot-pressing, and a method for producing it, as well as a polymer electrolyte fuel cell comprising such membrane electrode assemblies.

### SUMMARY OF THE INVENTION

As a result of intense research in view of the above objects, the inventors have found that in a membrane electrode assembly for a polymer electrolyte fuel cell comprising a polymer electrolyte membrane and electrodes having catalytic layers bonded to both surfaces of the electrolyte membrane, a self-humidifying function can be obtained by causing the electrode catalytic layers to partially project into the polymer electrolyte membrane, thereby making it possible to carry out the low-humidifying operation of the polymer electrolyte fuel cell. The inventors have also found that the use of a polymer electrolyte membrane having predetermined properties can lead to a membrane electrode assembly for a polymer electrolyte fuel cell having high power-generating performance and heat resistance. The present invention has been completed based on these findings.

Thus, the first membrane electrode assembly of the present invention comprises a pair of opposing electrodes each having a catalytic layer, and a polymer electrolyte membrane sandwiched by the electrodes, part of the catalytic layers being projecting into the polymer electrolyte membrane.

The second membrane electrode assembly of the present invention comprises a polymer electrolyte membrane having a softening point of 120° C. or more and a Q value of 0.09-0.18 C/cm².

The projection depth of the catalytic layer is preferably 0.5 μm or more and less than 5 μm. When there are arbitrary two points, whose linear distance is 10 μm or more, in an interface of the polymer electrolyte membrane with each of the catalytic layers, the distance along the interface is preferably longer than the linear distance by 15% or more on average.

The membrane electrode assembly having such a structure for a polymer electrolyte fuel cell is desirably designed, such that the DC resistance of the polymer electrolyte membrane in a thickness direction determined by impedance measurement is 90% or less of the DC resistance of a membrane electrode assembly having the same structure except that part of catalytic layers do not project into a polymer electrolyte membrane.

The polymer electrolyte membrane is preferably made of a sulfonated hydrocarbon polymer that may contain oxygen in its skeleton or other substituent groups than a sulfonic group. The sulfonated hydrocarbon polymer is preferably selected from the group consisting of sulfonated polyetheretherketone, sulfonated polysulfone, sulfonated polyethersulfone, sulfonated polyetherimide, sulfonated polyphenylene sulfide and sulfonated polyphenylene oxide.

The first method for producing a membrane electrode assembly comprising catalytic layers of a pair of opposing electrodes bonded to both surfaces of a polymer electrolyte membrane according to the present invention comprises the steps of (1) coating a catalytic layer of one electrode with a solution of a polymer electrolyte in an organic solvent, (2) coating the resultant polymer electrolyte membrane with a catalyst slurry for the other electrode, while the amount of the organic solvent remaining in the polymer electrolyte membrane is 5-20 weight % based on the polymer electrolyte membrane, and (3) after drying, hot-pressing the polymer electrolyte membrane and the electrodes formed on both sides of the membrane.

The second method for producing a membrane electrode assembly comprising a polymer electrolyte membrane having a softening point of 120° C. or higher and a Q value of 0.09-0.18 C/cm² according to the present invention comprises the steps of (1) forming the polymer electrolyte membrane from a solution of the polymer electrolyte, (2) hot-pressing the polymer electrolyte membrane and a pair of electrodes arranged on both sides of the membrane, while the amount of the organic solvent remaining in the polymer electrolyte membrane is 3-20 weight % based on the polymer electrolyte membrane, and then (3) drying the polymer electrolyte membrane. It is preferable to use N-methyl pyrrolidone as an organic solvent.

The polymer electrolyte fuel cell of the present invention is constituted by stacking a plurality of the above membrane electrode assemblies via separator plates.

### BRIEF DESCRIPTION OF THE DRAWINGS

FIG. 1 is a schematic view showing the structure of a membrane electrode assembly for a polymer electrolyte fuel cell according to the present invention;

FIG. 2 is a schematic cross-sectional view showing an apparatus for measuring the Q value of the membrane electrode assembly of the present invention;

FIG. 3 is a graph showing a discharge curve obtained as a result of measuring a current density in a predetermined voltage range, to determine the Q value of the membrane electrode assembly of the present invention;

FIG. 4 is a schematic cross-sectional view showing a state in which part of catalytic layers project into a polymer electrolyte membrane from both sides in the membrane electrode assembly of the present invention;

FIG. 5 is a schematic cross-sectional view showing the projection depth of the catalytic layers into the polymer electrolyte membrane;

FIG. 6 is a schematic cross-sectional view showing the length of an interface between a catalytic layer and the polymer electrolyte membrane;

FIG. 7 is a schematic cross-sectional view showing an apparatus for measuring the impedance of the membrane electrode assembly;

FIG. 8 is a graph showing the relation between an average projection depth and a cell resistance and a power-generating performance (cell voltage);

FIG. 9 is a graph showing the relation between an average interface length ratio and a power-generating performance (cell voltage);

FIG. 10 is a graph showing the relation between a DC resistance ratio and a cell resistance;

FIG. 11(a) is a graph showing the relation between a Q value and a generated voltage and a percent defective in the membrane electrode assemblies of EXAMPLES 8-11 and COMPARATIVE EXAMPLES 4 and 5; and

FIG. 11(b) is a graph showing the relation between a Q value and a generated voltage and a percent defective in the membrane electrode assemblies of EXAMPLES 12-16 and COMPARATIVE EXAMPLES 6 and 7.

### THE BEST MODE FOR CARRYING OUT THE INVENTION

The present invention will be explained below in detail referring to the drawings attached hereto, and it should be noted that this explanation is applicable to both of the first and second membrane electrode assemblies unless otherwise mentioned. Accordingly, even when the first and second membrane electrode assemblies are separately explained for convenience, such explanation is not applicable either one membrane electrode assembly but to both membrane electrode assemblies as long as it is possible from the technical point of view.

[1] Membrane Electrode Assembly

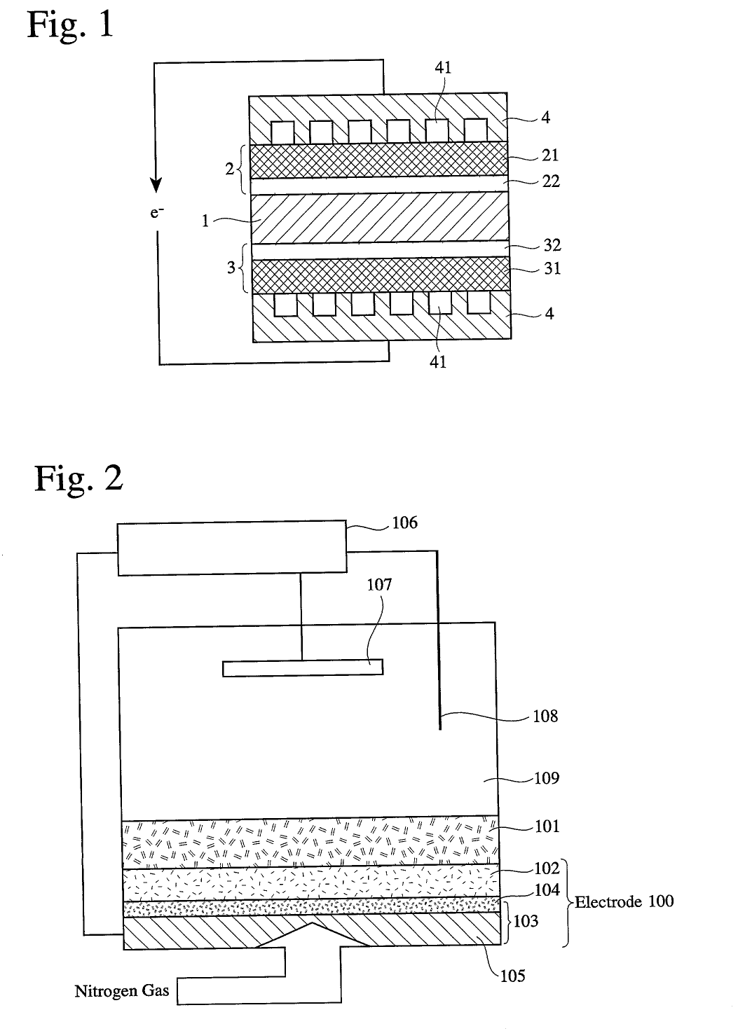

The polymer electrolyte fuel cell has a structure in which a plurality of membrane electrode assemblies generally shown in FIG. 1 are stacked via separator plates. Each membrane electrode assembly is constituted by a polymer electrolyte membrane 1, and a fuel electrode 2 and an oxygen electrode 3 on both sides of the membrane 1, these members being sandwiched by separator plates 4, 4. The fuel electrode 2 and the oxygen electrode 3 are respectively constituted by gas-diffusion layers 21, 31 and catalytic layers 22, 32.

(A) Polymer Electrolyte Membrane

The polymer electrolyte membrane of the present invention is made of a proton (ion) exchange resin, which may be not only sulfonated perfluorocarbon, but also a sulfonated hydrocarbon polymer such as sulfonated polyetheretherketone (PEEK), sulfonated phenoxybenzophenone-benzophenone copolymer, etc.

Particularly, in the case of forming a polymer electrolyte membrane having a softening point of 120° C. or higher and a Q value of 0.09-0.18 C/cm², it is preferable to use a sulfonated hydrocarbon polymer. The hydrocarbon polymers used for this purpose include non-fluorinated polymers having a carbonyl (—CO—) group, an ether (—O—) group, a sulfone (—SO₂—) group, a sulfide (—S—) group, an imide (—NH—) group, etc. in polymer skeletons or substituent groups composed of hydrocarbons. Specific examples of these sulfonated hydrocarbon polymers are particularly sulfonated polyetheretherketone, sulfonated polysulfone, sulfonated polyethersulfone, sulfonated polyetherimide, sulfonated polyphenylene sulfide and sulfonated polyphenylene oxide. These polymers may partially contain fluorine.

The sulfonated hydrocarbon polymer preferably has an ion exchange capacity (milli-equivalent of the sulfonic group per 1 g) of 1-2.6 meq/g. If its ion exchange capacity were less than 1 meq/g, it would fail to exhibit sufficient power-generating performance when formed into a polymer electrolyte membrane. On the other hand, if its ion exchange capacity were more than 2.6 meq/g, it would have insufficient heat resistance when formed into a polymer electrolyte membrane.

The sulfonated hydrocarbon polymer has a softening point (temperature at which their kinetic viscosity decreases) of 120° C. or higher. When the softening point is lower than 120° C., the polymer electrolyte membrane has insufficient heat resistance, likely to be thermally decomposed during hot pressing. The preferred softening point of the sulfonated hydrocarbon polymer is 125-300° C.

At least in the second membrane electrode assembly, the polymer electrolyte membrane should have a Q value (charge per a unit area) of 0.09-0.18 C/cm². When the Q value is less than 0.09 C/cm², it is impossible to obtain sufficient power-generating performance. On the other hand, when it exceeds 0.18 C/cm², the polymer electrolyte membrane has too low heat resistance, resulting in too high percent defective. The particularly preferable Q value of the polymer electrolyte membrane is 0.14-0.18 C/cm. Here, the Q value is the amount of electric charge per a unit area determined from a peak area of proton on an adsorption side in the scanning of voltage from −0.1 V to +0.7 V, in a cell in which the amount of platinum in the catalytic layer of each electrode is 0.5 mg/cm², and in which a polymer electrolyte membrane electrode assembly is surrounded by an aqueous sulfuric acid solution of pH 1 on one side and a nitrogen gas on the other side. The Q value may be regarded as an indicator of adhesion of the electrode to the polymer electrolyte membrane, and it has been found that with the Q value of 0.09-0.18 C/cm², an excellent polymer electrolyte membrane electrode assembly is obtained.

The measurement method of the Q value will be explained in detail referring to FIG. 2. A polymer electrolyte membrane electrode assembly to be measured comprises a polymer electrolyte membrane 101 and an electrode 100 formed on only one surface of the membrane 101. The electrode 100 is composed of a catalytic layer 102 and a gas-diffusion layer 103 (primary layer 104 and carbon paper 105). The polymer electrolyte membrane 101 is in contact with an aqueous sulfuric acid solution 109 of pH 1 on a side free from the electrode 100 and with a nitrogen gas on the side of the electrode 100. A reference electrode 108 is immersed in an aqueous sulfuric acid solution 109, while a control electrode 107 immersed in the aqueous sulfuric acid solution 109 is connected to the gas-diffusion layer 103 of the membrane electrode assembly.

When voltage is applied between the gas-diffusion layer 103 and the aqueous sulfuric acid solution 109 by a potentiostat 106, protons in the aqueous sulfuric acid solution 109 pass through the polymer electrolyte membrane 101 to the electrode 100, whereby electrons are exchanged through the electrolyte membrane 101. That is, as protons are attracted to the platinum surface in the catalyst particles, electrons are given from platinum. In an opposite case, electrons are transferred from the adsorbed hydrogen atoms to platinum and diffused as protons into the aqueous sulfuric acid solution.

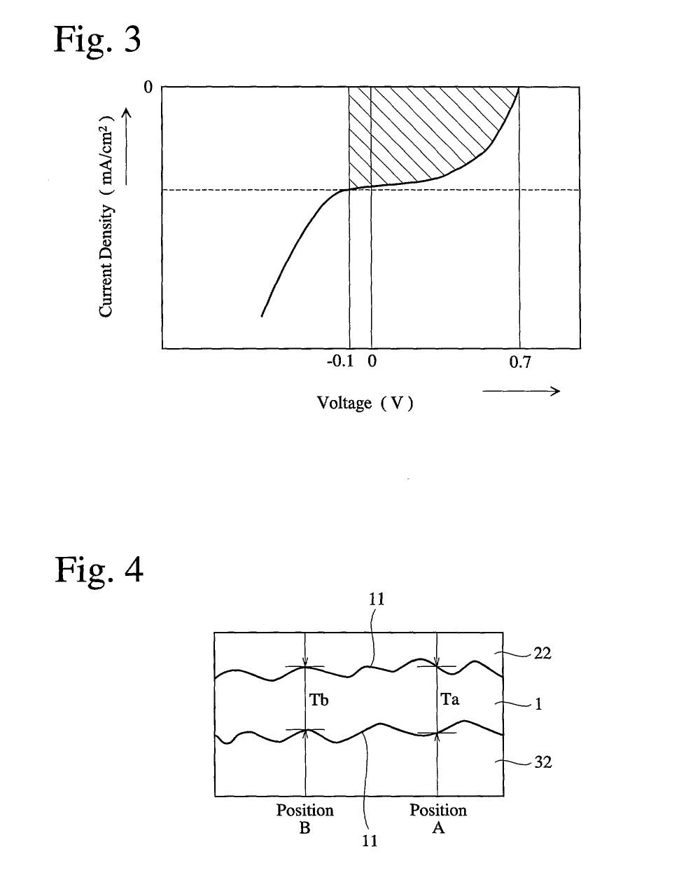

By scanning voltage from −0.1 V to +0.7 V, the Q value (C/cm²) can be determined from the proton peak area on the adsorption side. A typical measurement example is shown in FIG. 3. In the discharge curve shown in FIG. 3, the Q value is defined as the amount of electric charge per a unit area of the membrane electrode assembly, indicating that the larger the Q value, the higher the adhesion of the electrode 100 to the polymer electrolyte membrane 101.

The polymer electrolyte membrane used in the present invention preferably has a thickness of about 20-60 μm. When the thickness is less than about 20 μm, the electrodes are likely to be short-circuited. On the other hand, when the thickness is more than about 60 μm, a sufficient power-generating performance cannot be obtained.

(B) Electrode

The electrodes (oxygen electrode and fuel electrode) laminated on both sides of the polymer electrolyte membrane each consist of a gas-diffusion layer and a catalytic layer.

(1) Gas-Diffusion Layer

Referring to FIG. 1, the gas-diffusion layers 21, 31 of respective electrodes (fuel electrode 2 and oxygen electrode 3) function not only to transmit electrons between the electrode catalytic layers 22, 32 and the separator plates 4, 4, but also to diffuse a fuel gas (hydrogen) and an oxidizing gas (air) to the electrode catalytic layers 22, 32. Therefore, the gas-diffusion layers 21, 31 should have both electric conductivity and porosity. Specifically, each gas-diffusion layer 21, 31 preferably comprises a primary layer formed by coating a support layer such as a carbon paper, a carbon cloth, a carbon felt, etc. with a slurry of conductive particles such as carbon black particles dispersed in an ion-conducting binder, which may be the same polymer electrolyte as above. The primary layer preferably contains water-repellant particles [polytetrafluoroethylene (PTFE)] particles. In this case, a weight ratio of carbon black particles to PTFE is preferably 1/3-5/1. When the weight ratio of carbon black particles to PTFE particles is less than 1/3, the gas-diffusion layer has insufficient electric conductivity. Also, it is not useful to make the weight ratio more than 5/1.

(2) Catalytic Layer

Each catalytic layer 22, 32 is formed by coating each electrode gas-diffusion layer 21, 31 with a catalyst slurry obtained by uniformly dispersing catalyst particles composed of platinum particles, etc. carried on carbon black particles in a solution of an ion-conducting binder in organic solvent.

The ion-conducting binders may be the above sulfonated hydrocarbon polymers as well as other ion exchange resins such as Nafion®, etc. A weight ratio of the platinum particles to the carbon black particles is preferably 1/4-2/1, and a weight ratio of the catalyst particles (platinum particles +carbon black particles) to the ion-conducting binder is preferably 1/2-3/1.

(C) Projection of Catalytic Layer

The feature of the first membrane electrode assembly is that there are interfaces 11, 12 in a wave form between the polymer electrolyte membrane 1 and the electrode catalytic layers 22, 32 on both sides of the membrane 1 as shown in FIG. 4, whereby the electrode catalytic layers 22, 32 are partially projecting into the polymer electrolyte membrane 1. Because of the projection of the electrode catalytic layers 22, 32 into the polymer electrolyte membrane 1, the membrane electrode assembly exhibits not only a function inherent in an electrode catalyst, but also a function to generate water by the reaction of an oxygen gas and a hydrogen gas cross-leaking through the polymer electrolyte membrane 1. That is, because water formed by cross-leaking in the electrode/membrane interface under a low humidification condition and water formed by electrode reaction are efficiently diffused into the polymer electrolyte membrane 1, low-humidification operation is realized.

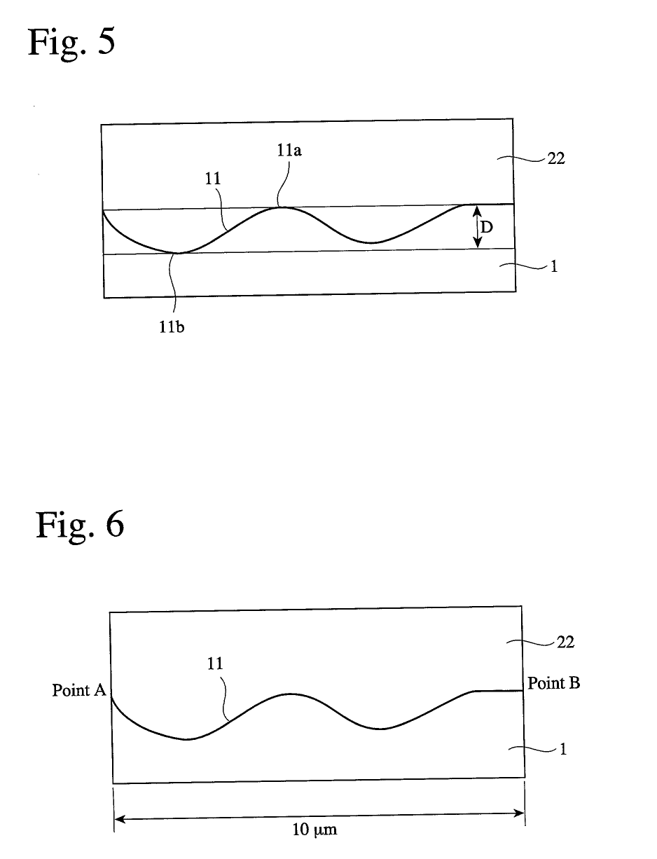

The degree of projection of the catalytic layer into the polymer electrolyte membrane can be expressed by an average projection depth and an average interface length. FIG. 5 shows the average projection depth D of the catalytic layer 22 into the polymer electrolyte membrane 1. Interfaces 11 between the catalytic layer 22 and the polymer electrolyte membrane 1 are arbitrarily selected in the number of n or more (usually 7) to measure the difference between a top 11a and a bottom 11b in each interface 11, and the resultant differences are averaged to determine the average projection depth D. In the present invention, the average projection depth D is preferably 0.5 μm or more and less than 5 μm. When the average projection depth D is less than 0.5 μm, sufficient contact cannot be obtained between the catalytic layer and the polymer electrolyte membrane, resulting in insufficient cross-leaking, thus insufficient self-humidifying function. On the other hand, when the average projection depth D is 5 μm or more, excessive cross-leaking takes place. The more preferred average projection depth D is 0.5-3 μm.

FIG. 6 shows the length of an interface 11 between the polymer electrolyte membrane 1 and the catalytic layer 22. The length of an interface 11 can be measured by a map meter, etc. When there are arbitrary two points A, B, whose linear distance is 10 μm or more, in the interface 11, the distance between the two points A, B along the interface 11 (simply called “interface length”) is longer than the linear distance by 15% or more on average. The average interface length ratio (average ratio of interface length/linear distance) is also obtained by averaging the interface length ratios at arbitrary n pairs of points (usually 7 pairs) or more. When the average interface length ratio is less than 15%, the interface 11 has insufficient roughness, failing to achieve not only sufficient contact between the catalytic layer and the polymer electrolyte membrane but also sufficient cross-leaking.

The degree of projection of the catalytic layers 22, 32 into the polymer electrolyte membrane 1 can be expressed by the DC resistance of the polymer electrolyte membrane 1. Because the DC resistance in a thickness direction determined by the impedance measurement of the membrane electrode assembly is proportional to the average distance between the electrodes 2, 3, the fact that the DC resistance is small means that the degree of projection of the catalytic layers 22, 32 is large. When there is a large degree of projection in the catalytic layers 22, 32, electrochemical distance between the electrodes is shortened by the projection effects of the catalytic layers 22, 32, while keeping strength and durability because the polymer electrolyte membrane 1 substantially maintains a physical average membrane thickness, thereby increasing the effect of reversely diffusing the generated water in the polymer electrolyte membrane 1.

Assuming that the DC resistance of the membrane electrode assembly is R₀ when part of the catalytic layers 22, 32 are not projecting into the polymer electrolyte membrane 1, substantially corresponding to the DC resistance of the polymer electrolyte membrane 1, the DC resistance R of the membrane electrode assembly when part of the catalytic layers 22, 32 are projecting into the polymer electrolyte membrane 1 is preferably 90% or less of R₀. When the DC resistance ratio (ratio of R/R₀) is more than 90%, the catalytic layers 22, 32 do not have sufficient degree of projection, failing to achieve a self-humidifying function.

Incidentally, because the catalytic layers 22, 32 are partially projecting into the electrolyte membrane 1 as shown in FIG. 4, the average membrane thickness T of the polymer electrolyte membrane 1 can be determined by the following method. First, in a photograph showing the cross section of the membrane, a membrane thickness Ta is measured at an arbitrary position A, and a membrane thickness Th is similarly measured at another position B. Such measurement is carried out at a large number of (preferably 7 or more) positions to average the measured thickness values. The resultant average value is regarded as the average membrane thickness.

(D) Separator Plate

Each separator plate 4 is a metal plate provided with a large number of grooves 41 for gas passage at least one surface (usually both surfaces) not only for separating the membrane electrode assemblies, but also for serving as fixing members when the membrane electrode assemblies are stacked.

[2] Method for Producing Membrane Electrode Assembly

(A) Formation of Electrode

(1) Production of Catalyst Slurry

Taking a platinum catalyst as an example, the formation of the electrode is explained below. First, carbon black particles are caused to carry platinum particles to form catalyst particles. The resultant catalyst particles are uniformly dispersed in a solution of an ion-conducting binder, which may be the same as the above polymer electrolyte, in an organic solvent, to prepare a catalyst slurry. The organic solvents may be dimethyl acetamide (boiling point: 165.5° C.), dimethylformamide (boiling point: 153° C.), dimethyl sulfoxide (boiling point: 189° C.), triethylphosphate (boiling point: 115° C.), N-methylpyrrolidone (boiling point: 202° C.), etc. Incidentally, a weight ratio of catalyst particles/polymer electrolyte in the catalyst slurry is preferably 1/2-3/1.

(2) Production of Gas-Diffusion Layer

A slurry comprising carbon black particles and particles of polytetrafluoroethylene (PTFE), etc. at a weight ratio of 1/3-5/1 uniformly dispersed in a solvent such as ethylene glycol, etc. is coated on one surface of a support layer such as a carbon paper, etc., and dried to form a primary layer, thereby providing a gas-diffusion layer constituted by the support layer and the primary layer. The thickness of the primary layer may be about 1-3 mg/cm².

(3) Formation of Catalytic Layer

The catalyst slurry obtained in the above step (1) is coated on the primary layer of the gas-diffusion layer in such an amount that the amount of platinum is 0.3-0.5 mg/cm² and dried, to produce a catalytic layer of the electrode.

(B) Formation of Polymer Electrolyte Membrane

(1) First Membrane Electrode Assembly

In the formation of the electrode catalytic layer on the polymer electrolyte membrane, the concentration of an organic solvent remaining in the polymer electrolyte membrane should be 5-20 weight %. Accordingly, a solution of a polymer electrolyte in an organic solvent is applied to the catalytic layer of one electrode, and when the concentration of the organic solvent remaining in the polymer electrolyte membrane becomes 5-20 weight %, the catalyst slurry for the other electrode is applied to a surface of the membrane, followed by bonding a gas-diffusion layer for the other electrode thereto.

Specifically, a solution of a polymer electrolyte in an organic solvent is first applied to the catalytic layer of one electrode. The amount of an organic solvent remaining in the catalytic layer on one electrode is preferably about 5-20 weight %, more preferably about 5-15 weight %. Also, the concentration of the polymer electrolyte solution is in general preferably 5-30 weight %, more preferably 10-15 weight %. When the concentration of the polymer electrolyte solution is less than 5 weight %, the projection depth of the catalytic layer is too large, and too much application is needed to achieve the desired membrane thickness. On the other hand, when the concentration is more than 30 weight %, the polymer electrolyte solution has too high viscosity, resulting in difficulty in application.

After drying the resultant polymer electrolyte membrane until the amount of the remaining organic solvent becomes 5-20 weight %, the membrane is coated with a catalyst slurry for the other electrode. When the amount of an organic solvent remaining in the polymer electrolyte membrane is less than 5 weight %, the projection of the catalytic layer into the membrane is insufficient. On the other hand, when it is more than 20 weight %, the projection depth of the catalytic layer is too large. The preferred amount of the remaining organic solvent is 5-15 weight %.

The catalyst slurry applied to the polymer electrolyte membrane preferably has as small a concentration of a solid component as 3-10 weight %. When the solid component concentration of the catalyst slurry is less than 3 weight %, the catalytic layer has a too large projection depth. On the other hand, when it exceeds 10 weight %, the projection of the catalytic layer is insufficient. After drying the resultant catalytic layer, a gas-diffusion layer for the other electrode is laminated.

The interface between the polymer electrolyte membrane and the catalytic layer can be provided with a desired wave form, by (a) adjusting the viscosity, the type of an organic solvent and the drying time, etc. of the catalyst slurry, (b) spraying an organic solvent onto the catalytic layer, or (c) adjusting the viscosity and casting pressure, etc. of the polymer electrolyte solution applied to the catalytic layer.

(2) Second Membrane Electrode Assembly

A solution of a sulfonated hydrocarbon polymer in an organic solvent is formed into a membrane having a thickness corresponding to a dry thickness of 20-60 μm by a solution-casting method, etc. The preferred organic solvents are N-methyl pyrrolidone, dimethyl sulfoxide, dimethyl acetamide, etc.

With respect to a drying treatment after forming the membrane, it does not completely dry the membrane, but the amount of organic solvent remaining in the membrane is preferably adjusted to 3-20 weight %. Because the sulfonated hydrocarbon polymer has a high softening point, the workability of the membrane should be improved by causing a small amount of an organic solvent to remain in the membrane. Accordingly, when the amount of the remaining organic solvent is less than 3 weight %, hot-pressing needs high temperature to closely adhere the polymer electrolyte membrane to the electrode, resulting in likelihood of the decomposition of the sulfonic group, etc. in the polymer electrolyte membrane. On the other hand, when the amount of the remaining organic solvent exceeds 20 weight %, the polymer electrolyte membrane is so soft that it is likely to be ruptured during hot-pressing, and that it takes too much time to remove an organic solvent after the hot-pressing. The more preferred amount of the remaining organic solvent is 5-15 weight %.

The polymer electrolyte membrane in which 3-20 weight % of an organic solvent remains is sandwiched by an oxygen electrode and a fuel electrode each constituted by the above electrode.

(C) Hot Pressing

In both of the first and second membrane electrode assemblies, a laminate of an electrode and a polymer electrolyte membrane/electrode is hot-pressed. The hot-pressing conditions are in general preferably a temperature of 60-200° C. and a pressure of 1-10 MPa for 1-5 minutes. Though hot-pressing may be carried out only once, it may consist of a first hot-pressing at relatively low temperature, and then a second hot-pressing at a relatively high temperature for a short period of time. In the latter case, the first hot pressing conditions are about 60-100° C. (for instance, about 80° C.) and about 1-10 MPa (for instance, about 2.5 MPa) for about 1-5 minutes (for instance, 2 minutes), and the second hot pressing conditions are about 120-200° C. (for instance, 160° C.) and about 1-10 MPa (for instance, about 3 MPa) for about 1-5 minutes (for instance, 1 minute).

In the case of the polymer electrolyte membrane made of a sulfonated hydrocarbon polymer having a softening point of 120° C. or higher, the hot-pressing temperature may be at least about 120° C., because the membrane contains a small amount of an organic solvent. With respect to the upper limit of the hot-pressing temperature, it is preferably 160° C. or lower to prevent the polymer structure of the polymer electrolyte membrane from suffering thermal decomposition.

The present invention will be described in detail referring to EXAMPLES below without intention of limiting the present invention thereto.

### EXAMPLE 1

Production and Evaluation of First Membrane Electrode Assembly

(1) Production of Catalyst Slurry

Platinum particles were carried on carbon black (furnace black) particles at a platinum/carbon weight ratio of 1:1 to form catalyst particles. Separately, polyetheretherketone (available from Aldrich) was introduced into fuming sulfuric acid so that it was sulfonated to an ion exchange capacity (milli-equivalent of a sulfonic group per 1 g) of 2.4 meq/g, thereby obtaining sulfonated polyetheretherketone. The sulfonated polyetheretherketone was dissolved in N-methylpyrrolidone (available from Aldrich) while refluxing, to form a sulfonated polyetheretherketone solution at a concentration of 12 weight %. This sulfonated polyetheretherketone solution was mixed with the catalyst particles to form a catalyst slurry at a weight ratio (catalyst particles/sulfonated polyetheretherketone) of 1:2.

(2) Production of Gas-Diffusion Layer

A slurry comprising carbon black particles and polytetrafluoroethylene (PTFE) particles at a weight ratio of 1:1.5 uniformly dispersed in ethylene glycol was applied to one surface of a carbon paper, and dried to form a primary layer, thereby forming a gas-diffusion layer constituted by the carbon paper and the primary layer.

(3) Production of One Electrode

The catalyst slurry obtained in the above step (1) was applied to the primary layer of the gas-diffusion layer such that the amount of platinum was 0.3 mg/cm², dried at 60° C. for 10 minutes and then vacuum-dried at 120° C., to form one electrode having a catalytic layer. The amount of the organic solvent remaining in this catalytic layer was 5.0 weight %.

(4) Production of Polymer Electrolyte Solution

The sulfonated polyetheretherketone obtained in the above step (1) was dissolved in N-methyl pyrrolidone while refluxing, to form a polymer electrolyte solution having a viscosity of 7000 cps.

(5) Production of Membrane Electrode Assembly

The catalytic layer of one electrode obtained in the step (3) was coated with the polymer electrolyte solution obtained in the step (4) at an average dry membrane thickness of 50 μm. After drying until the concentration of the organic solvent remaining in the membrane reached 5.0 weight %, the catalyst slurry obtained in the step (1) was applied. The first hot pressing was carried out under the conditions of 80° C., 5 MPa and 2 minutes, and then the second hot pressing was carried out under the conditions of 160° C., 4 MPa and 1 minute, to form a membrane electrode assembly.

(6) Evaluation of Properties

(a) Measurement of Projection Depth

According to the method shown in FIG. 5, the projection depth of the catalytic layer into the polymer electrolyte membrane was measured at 9 points, to determine an average projection depth from the measured values. The results are shown in Table 1.

(b) Measurement of Interface Length

According to the method shown in FIG. 6, the length of an interface between the catalytic layer and the polymer electrolyte membrane was measured at 9 points, to determine an average interface length from the measured values. The results are shown in Table 1.

(c) Measurement of DC Resistance Ratio

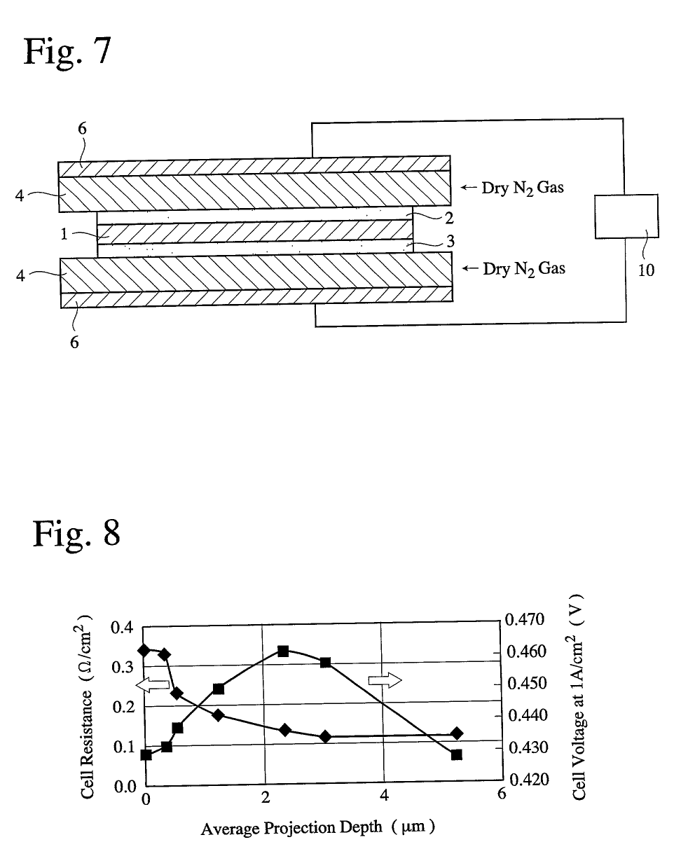

As shown in FIG. 7, the membrane electrode assembly constituted by the polymer electrolyte membrane 1 and a pair of electrodes 2, 3 was sandwiched by a pair of separator plates 4, 4 and then by current-collecting plates 6, 6, which were connected to an impedance analyzer 10. After drying the polymer electrolyte membrane 1 by flowing a dry nitrogen gas through both separator plates 4, 4, its DC resistance R in the membrane thickness direction was measured. The membrane electrode assembly having no catalytic layer projection was also measured with respect to the DC resistance R₀ in a membrane thickness direction by the same method. The measured resistance values was used to determine a DC resistance ratio (R/R₀ ratio). The results are shown in Table 1.

(d) Measurement of Cell Resistance

An apparatus shown in FIG. 7 was used to generate electric power, with the air flowing through one electrode 4 and a pure hydrogen gas flowing through the other electrode 4. The power generation conditions were a gas pressure of 100 kPa, a utility ratio of 50%, and a dew point of 80° C. for both electrodes. The cell pressure was atmospheric. The humidification was indirect humidification by a cathode gas. The cell resistance (Ω/cm²) at a current density of 1 A/cm² was measured under these conditions. The results are shown in Table 1.

(e) Evaluation of Power-Generating Performance

An apparatus shown in FIG. 7 was used to generate electric power, with the air flowing through one electrode 4 and a pure hydrogen gas flowing through the other electrode 4. The power generation conditions were a gas pressure of 100 kPa, a utility ratio of 50%, and a dew point of 80° C. for both electrodes. The cell pressure was atmospheric. The humidification was indirect humidification by a cathode gas. The cell voltage at a current density of 1A/cm² was measured under these conditions. The results are shown in Table 1.

### EXAMPLE 2

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 10.6 weight %, and the resultant membrane electrode assembly was evaluated in the same manner as in EXAMPLE 1. The results are shown in Table 1 and FIGS. 8 and 9.

### EXAMPLE 3

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 14.4 weight %, and the resultant membrane electrode assembly was evaluated in the same manner as in EXAMPLE 1. The results are shown in Table 1 and FIGS. 8 and 9.

### EXAMPLE 4

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 20.0 weight %, and the resultant membrane electrode assembly was evaluated in the same manner as in EXAMPLE 1. The results are shown in Table 1 and FIGS. 8 and 9.

### EXAMPLE 5

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 10.6 weight %, and the resultant membrane electrode assembly was evaluated in the same manner as in EXAMPLE 1. The results are shown in Table 1 and FIGS. 8 and 9.

### EXAMPLE 6

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 10.6 weight %, and the resultant membrane electrode assembly was evaluated in the same manner as in EXAMPLE 1. The results are shown in Table 1 and FIGS. 8 and 9.

### EXAMPLE 7

A membrane electrode assembly was produced under the same conditions as in EXAMPLE 1, except that the polymer electrolyte solution coated on the catalytic layer had a viscosity of 7000 cps, and that the catalyst slurry was applied after drying the polymer electrolyte membrane such that the concentration of an organic solvent remaining therein was 10.6 weight %, and the resultant membrane electrode assembly was evaluated in the same manner as in EXAMPLE 1. The results are shown in Table 1 and FIGS. 8 and 9.

### COMPARATIVE EXAMPLE 1

A membrane electrode assembly was produced under the same conditions as in EXAMPLE 1, except that the polymer electrolyte solution was cast to form a polymer electrolyte membrane, and that after drying until the concentration of the remaining organic solvent reached 2.2 weight %, the catalyst slurry was coated on both surfaces of the membrane at a platinum amount of 0.3 mg/cm², and the resultant membrane electrode assembly was evaluated in the same manner as in EXAMPLE 1. The results are shown in Table 1 and FIGS. 8 and 9.

### COMPARATIVE EXAMPLE 2

A membrane electrode assembly was produced under the same conditions as in EXAMPLE 1, except that the polymer electrolyte solution having a viscosity of 7000 cps was coated on the catalytic layer, and that after drying until the concentration of an organic solvent remaining in the polymer electrolyte membrane reached 4.1 weight %, the catalyst slurry was coated thereon, and the resultant membrane electrode assembly was evaluated in the same manner as in EXAMPLE 1. The results are shown in Table 1 and FIGS. 8 and 9.

### COMPARATIVE EXAMPLE 3

A membrane electrode assembly was produced under the same conditions as in EXAMPLE 1, except that the catalyst slurry was sprayed onto the catalytic layer, and that after adjusting its surface roughness, a polymer electrolyte solution having a viscosity of 7000 cps was coated on this catalytic layer in such an amount that the resultant membrane had an average dry membrane thickness of 50 μm, and that after drying until the concentration of an organic solvent remaining in the polymer electrolyte membrane reached 22.0 weight %, the catalyst slurry was coated thereon, and the resultant membrane electrode assembly was evaluated in the same manner as in EXAMPLE 1. The results are shown in Table 1 and FIGS. 8 and 9.

TABLE 1

| | Membrane | Remaining | Projection | Interface | Average | | | Cell | |
|---|---|---|---|---|---|---|---|---|---|
| | Thickness | Solvent | Depth | Length | Interface | Resistance | R/R₀** | Resistance | Cell Voltage |
| No. | (μm) | (weight %) | (μm) | (μm) | Length Ratio | R* | (%) | (Ω/cm²) | (V) |
| EXAMPLE | 50 | 5.0 | 0.5 | 12.2 | 1.22 | 800 | 88.89 | 0.24 | 0.439 |
| 1 | | | | | | | | | |
| EXAMPLE | 50 | 10.6 | 1.2 | 12.0 | 1.2 | 717 | 79.67 | 0.18 | 0.442 |
| 2 | | | | | | | | | |
| EXAMPLE | 50 | 14.4 | 2.3 | 12.4 | 1.24 | 576 | 64.00 | 0.14 | 0.462 |
| 3 | | | | | | | | | |
| EXAMPLE | 50 | 20.0 | 3.0 | 12.2 | 1.22 | 300 | 33.33 | 0.12 | 0.458 |
| 4 | | | | | | | | | |
| EXAMPLE | 50 | 10.6 | 1.2 | 12.2 | 1.22 | 716 | 79.56 | 0.17 | 0.460 |
| 5 | | | | | | | | | |
| EXAMPLE | 50 | 10.6 | 1.2 | 13.0 | 1.3 | 718 | 79.78 | 0.18 | 0.463 |
| 6 | | | | | | | | | |
| EXAMPLE | 50 | 10.6 | 1.2 | 14.0 | 1.4 | 717 | 79.67 | 0.17 | 0.461 |
| 7 | | | | | | | | | |
| COM. EX. | 50 | 2.2 | 0 | 10.0 | 1.0 | 900 | 100.00 | 0.35 | 0.431 |
| 1 | | | | | | | | | |
| COM. EX. | 50 | 4.1 | 0.3 | 12.0 | 1.2 | 842 | 93.56 | 0.34 | 0.433 |
| 2 | | | | | | | | | |
| COM. EX. | 50 | 22.0 | 5.2 | 14.5 | 1.45 | 337 | 37.44 | 0.12 | 0.428 |
| 3 | | | | | | | | | |

Note
*Resistance in a dry state.
**R₀ = 900 Ω.

FIG. 8 shows the relation between an average projection depth and a cell resistance and a power-generating performance (cell voltage). When the average projection depth became 0.5 μm or more, drastic decrease in the cell resistance was observed. However, at a time when the average projection depth exceeded 3 μm, the cell resistance became almost constant, indicating that influence by the average projection depth was saturated. With respect to the power-generating performance, it reached a peak at an average projection depth of around 2 μm, and its increase trend was reduced after exceeding that average projection depth. This indicates that the average projection depth is preferably 0.5 μm or more and less than 5 μm, particularly 0.5-3 μm.

FIG. 9 shows the relation between an average interface length ratio and a power-generating performance (cell voltage). At the average interface length ratio of 1.15 or so, drastic decrease in the power-generating performance was observed. When the average interface length ratio reached about 1.25, the effect of increasing the power-generating performance was saturated. This indicates that the average interface length ratio is preferably about 1.15 or more, particularly 1.15-1.25.

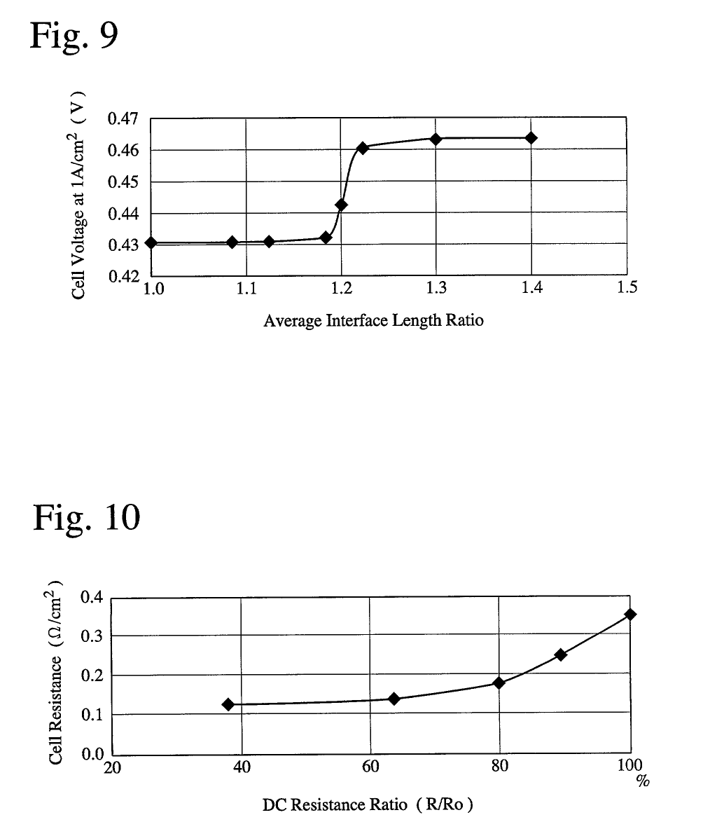

FIG. 10 shows the relation between a DC resistance ratio shown in Table 1 and a cell resistance. When the DC resistance ratio became 90% or less, extremely drastic decrease in the cell resistance was observed. Also, when the DC resistance ratio reached about 50%, the effect of decreasing the cell resistance was saturated. This indicates that the DC resistance ratio is preferably 90% or less.

### EXAMPLE 8

Production of Second Membrane Electrode Assembly

(1) Production of Polymer Electrolyte Membrane

Fuming sulfuric acid was added to polyetheretherketone (PEEK) to sulfonate PEEK, thereby obtaining sulfonated polyetheretherketone having an ion exchange capacity of 1.25 meq/g. This was dissolved in N-methyl pyrrolidone as an organic solvent while refluxing to obtain a sulfonated polyetheretherketone solution having a concentration of 12 weight %. This solution was cast to form a polymer electrolyte membrane (content of dissolved solvent: 5 weight %) having a thickness of 50 μm.

(2) Production of Catalyst Paste

Carbon black particles (furnace black) was caused to carry platinum particles at a weight ratio of 1:1 to produce catalyst particles. In addition, using a Nafion® resin (available from du Pont) as an ion-conducting binder, the catalyst particles were uniformly dispersed in a Nafion® resin solution to produce a catalyst paste at a weight ratio (catalyst particles: Nafion® resin) of 8:5.

(3) Production of Gas-Diffusion layer

A slurry obtained by dispersing carbon black particles (furnace black) and polytetrafluoroethylene (PTFE) particles in ethylene glycol was coated on one surface of a carbon paper, which was dried to provide a gas-diffusion layer.

(4) Production of Electrode

A catalyst paste obtained in the step (2) was screen-printed on a primary layer of the gas-diffusion layer, and after drying at 60° C. for 10 minutes, vacuum drying was carried out at 120° C. for 60 minutes to form a catalytic layer on the gas-diffusion layer. Incidentally, the concentration of the catalyst paste coated was adjusted such that the amount of platinum on the electrode was 0.5 mg/cm². Thus, a pair of an oxygen electrode and a fuel electrode were obtained.

(5) Production of Membrane Electrode Assembly

The polymer electrolyte membrane obtained in the above step (1), which contained 5 weight % of an N-methyl pyrrolidone organic solvent, was sandwiched by the oxygen electrode and the fuel electrode obtained in the above step (4), and hot-pressed at a temperature of 120° C. and a pressure of 2.5 MPa for 2 minutes to produce a membrane electrode assembly. The resultant membrane electrode assembly was introduced into a vacuum furnace to completely dry the polymer electrolyte membrane.

### EXAMPLE 9

A membrane electrode assembly was produced in the same manner as in EXAMPLE 8, except that using a polymer electrolyte membrane containing 3 weight % of an N-methyl pyrrolidone organic solvent in the step (5) of

### EXAMPLE 8, hot-pressing was carried out at a temperature of 150° C. and a pressure of 2.5 MPa for 2 minutes.

### EXAMPLE 10

A membrane electrode assembly was produced in the same manner as in EXAMPLE 8, except for carrying out a first hot-pressing at a temperature 80° C. and a pressure of 2.5 MPa for 2 minutes in the step (5) of EXAMPLE 8, and then carrying out a second hot-pressing at a temperature 160° C. and a pressure of 3 MPa for 1 minute.

### EXAMPLE 11

A membrane electrode assembly was produced in the same manner as in EXAMPLE 8, except that using a polymer electrolyte membrane containing 10 weight % of an N-methyl pyrrolidone organic solvent in the step (5) of EXAMPLE 8, hot-pressing was carried out at a temperature of 160° C. and a pressure of 2.5 MPa for 2 minutes.

### COMPARATIVE EXAMPLE 4

A membrane electrode assembly was produced in the same manner as in EXAMPLE 8, except that using a polymer electrolyte membrane containing 1 weight % of an N-methyl pyrrolidone organic solvent, hot-pressing was carried out at a temperature of 120° C. and a pressure of 2.5 MPa for 2 minutes in the step (5) of EXAMPLE 8.

### COMPARATIVE EXAMPLE 5

A membrane electrode assembly was produced in the same manner as in EXAMPLE 8, except that a polymer electrolyte membrane containing 25 weight % of an N-methyl pyrrolidone organic solvent, hot-pressing was carried out at a temperature of 180° C. and a pressure of 2.5 MPa for 2 minutes in the step (5) of EXAMPLE 8.

Evaluation of Examples 8-11 and Comparative Examples 4 and 5

(1) Measurement of Q Value

Using an apparatus shown in FIG. 2, the Q value of each membrane electrode assembly in EXAMPLES 8-11 and COMPARATIVE EXAMPLES 4 and 5 was measured in a range from −0.1 V to +0.7 V. The measurement results are shown in Table 2.

(2) Measurement of Generated Voltage

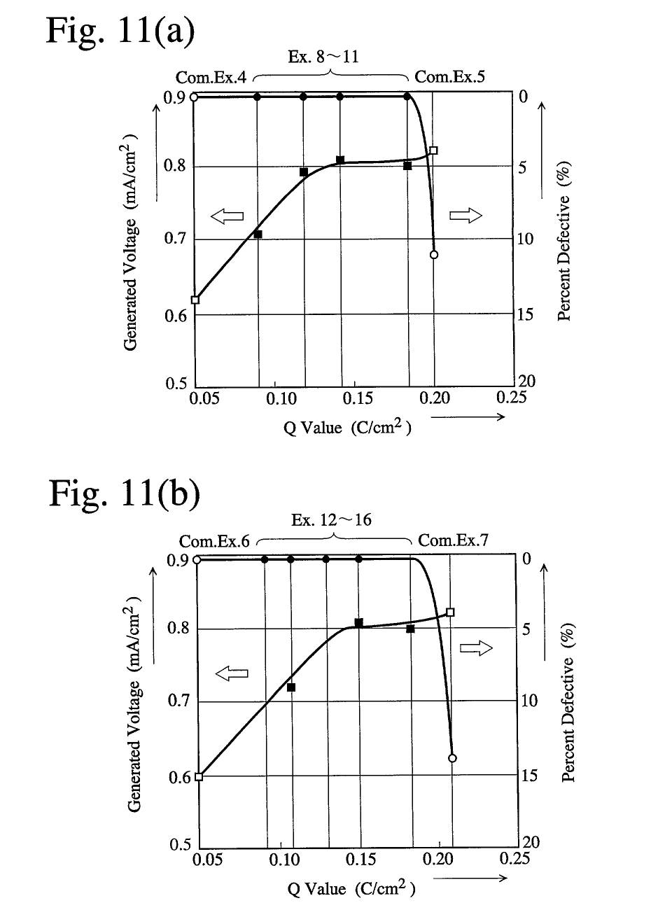

Using a single cell comprising each membrane electrode assembly in EXAMPLES 8-11 and COMPARATIVE EXAMPLES 4 and 5, electric power was generated with the air supplied to an oxygen electrode and pure hydrogen supplied to a fuel electrode, and cell voltage V was measured at a current density i of 0.2 A/cm². The measurement conditions were pressure of 100 kPa, utility percentage of 50%, relative humidity of 50% and a temperature of 85° C. for both of the oxygen electrode and the fuel electrode. The measurement results are shown in Table 2 and FIG. 11(a).

(3) Measurement of Percent Defective

Using a single cell comprising each membrane electrode assembly of EXAMPLES 8-11 and COMPARATIVE EXAMPLES 4 and 5, a He gas at a pressure of 0.5 kPa was supplied to the cell from one side to measure the volume of a He gas passing through the cell to the other side per a unit time, thereby determining the amount of He leaked. By measuring 50 cells for each EXAMPLE and COMPARATIVE EXAMPLE, those in which the amount of He leaked was 0.1 ml/(cm²×minute) or more were counted as defective products. The results are shown in Table 2 and FIG. 11(a).

TABLE 2
Membrane electrode assembly comprising polymer electrolyte membrane
made of sulfonated polyetheretherketone

| | Q value | Remaining Solvent | Hot-Pressing | | Percent | Generated |
|---|---|---|---|---|---|---|
| No. | (C/cm²) | (wt. %) | First | Second | Defective | Voltage |
| COM. EX. | 0.05 | 1 | 120° C., | — | <1% | 0.62 V |
| 4 | | | 2.5 MPa, | | | |
| | | | 2 min. | | | |
| EXAMPLE | 0.09 | 5 | 120° C., | — | <1% | 0.71 V |
| 8 | | | 2.5 MPa, | | | |
| | | | 2 min. | | | |
| EXAMPLE | 0.12 | 3 | 150° C., | — | <1% | 0.79 V |
| 9 | | | 2.5 MPa, | | | |
| | | | 2 min. | | | |
| EXAMPLE | 0.14 | 5 | 80° C., | 160° C., | <1% | 0.81 V |
| 10 | | | 2.5 MPa, | 3 MPa, | | |
| | | | 2 min. | 1 min. | | |
| EXAMPLE | 0.18 | 10 | 160° C., | — | <1% | 0.80 V |
| 11 | | | 2.5 MPa, | | | |
| | | | 2 min. | | | |
| COM. EX. | 0.20 | 25 | 180° C., | — | 11% | 0.82 V |
| 5 | | | 2.5 MPa, | | | |
| | | | 2 min. | | | |

As is clear from Table 2 and FIG. 11(a), when the Q value of the membrane electrode assembly is less than 0.09 C/cm², only low voltage is generated. On the other hand, when the Q value is more than 0.18 C/cm², there is high percent defective. Accordingly, in the membrane electrode assembly having sulfonated polyetheretherketone used as a sulfonated hydrocarbon polymer, the polymer electrolyte membrane should have a Q value of 0.09-0.18 C/cm².

### EXAMPLE 12

Production of the Second Membrane Electrode Assembly

(1) Production of Polymer Electrolyte Membrane

Polysulfone was introduced into fuming sulfuric acid to form sulfonated polysulfone having an ion exchange capacity of 1.5 meq/g. It was dissolved in N-methyl pyrrolidone as an organic solvent while refluxing to obtain a sulfonated polysulfone solution having a concentration of 10 weight %. This solution was cast to form a polymer electrolyte membrane (organic solvent content: 5 weight %) having a thickness of 40 μm.

(2) Production of Catalytic Layer

Carbon black particles (furnace black) were caused to carry platinum particles having an average particle size of 350 nm at a weight ratio of 1:1 to produce catalyst particles. Also, using a Nafion® resin (available from du Pont) as an ion-conducting binder, the catalyst particles were uniformly dispersed in a solution of the Nafion® resin in N-methyl pyrrolidone as a solvent, to produce a catalyst paste in which a weight ratio of the catalyst particles to the Nafione resin was 1:1.

(3) Production of Gas-Diffusion Layer

A slurry obtained by dispersing carbon black particles (furnace black) and polytetrafluoroethylene (PTFE) particles in ethylene glycol was coated on one surface of a carbon paper, which was dried to produce a gas-diffusion layer.

(4) Production of Electrode

The catalyst paste obtained in the step (2) was screen-printed on a primary layer of the gas-diffusion layer, and after drying at 60° C. for 10 minutes, vacuum drying was carried out at 120° C. for 60 minutes to form a catalytic layer on the gas-diffusion layer. Incidentally, the amount of the catalyst paste coated was adjusted such that the amount of platinum on the electrode was 0.5 mg/cm². Thus, a pair of an oxygen electrode and a fuel electrode were obtained.

(5) Production of Membrane Electrode Assembly

A polymer electrolyte membrane obtained in the above step (1), which contained 15 weight % of an N-methyl pyrrolidone organic solvent, was sandwiched by the oxygen electrode and the fuel electrode obtained in the above step (4), and hot-pressed at a temperature 150° C. and a pressure of 2.5 MPa for 2 minutes, to produce a membrane electrode assembly. The membrane electrode assembly was introduced into a vacuum furnace to completely dry the polymer electrolyte membrane.

### EXAMPLE 13

A membrane electrode assembly was produced in the same manner as in EXAMPLE 12, except for using the polymer electrolyte membrane obtained in the step (5) of EXAMPLE 12, which contained 20 weight % of an N-methyl pyrrolidone organic solvent, and hot-pressing at a temperature of 120° C. and a pressure of 2.5 MPa for 2 minutes.

### EXAMPLE 14

A membrane electrode assembly was produced in the same manner as in EXAMPLE 12, except for using the polymer electrolyte membrane obtained in the step (5) of EXAMPLE 12, which contained 10 weight % of an N-methyl pyrrolidone organic solvent, and carrying out a first hot-pressing at a temperature of 80° C. and a pressure of 1.5 MPa for 2 minutes and then a second hot-pressing at a temperature of 160° C. and a pressure of 2 MPa for 1 minute.

### EXAMPLE 15

A membrane electrode assembly was produced in the same manner as in EXAMPLE 12, except for using the polymer electrolyte membrane obtained in the step (5) of EXAMPLE 12, which contained 10 weight % of an N-methyl pyrrolidone organic solvent, and carrying out a first hot-pressing at a temperature of 80° C. and a pressure of 2.5 MPa for 2 minutes and then a second hot-pressing at a temperature of 160° C. and a pressure of 2 MPa for 1 minute.

### EXAMPLE 16

A membrane electrode assembly was produced in the same manner as in EXAMPLE 12, except for using the polymer electrolyte membrane obtained in the step (5) of EXAMPLE 12, which contained 5 weight % of an N-methyl pyrrolidone organic solvent, and hot-pressing at a temperature of 120° C. and a pressure of 2.5 MPa for 2 minutes.

### COMPARATIVE EXAMPLE 6

A membrane electrode assembly was produced in the same manner as in EXAMPLE 12, except for using the polymer electrolyte membrane obtained in the step (5) of EXAMPLE 12, which contained 25 weight % of an N-methyl pyrrolidone organic solvent, and hot-pressing at a temperature of 80° C. and a pressure of 2.5 MPa for 2 minutes.

### COMPARATIVE EXAMPLE 7

A membrane electrode assembly was produced in the same manner as in EXAMPLE 12, except for using the polymer electrolyte membrane obtained in the step (5) of EXAMPLE 12, which contained 1 weight % of an N-methyl pyrrolidone organic solvent, and hot-pressing at a temperature of 180° C. and a pressure of 2.5 MPa for 2 minutes.

Evaluation of Examples 12-16 and Comparative Examples 6 and 7

(1) Measurement of Q Value

Using the apparatus shown in FIG. 2, the Q value of each membrane electrode assembly in EXAMPLES 12-16 and COMPARATIVE EXAMPLES 6 and 7 was measured in a range from −0.1 V to +0.7 V. The measurement results are shown in Table 3.

(2) Measurement of Generated Voltage

Using a single cell comprising each membrane electrode assembly in EXAMPLES 12-16 and COMPARATIVE EXAMPLES 6 and 7, electric power was generated with air supplied to the oxygen electrode and pure hydrogen supplied to the fuel electrode, to measure its cell voltage V at a current density i of 0.2A/cm². The measurement conditions were pressure of 100 kPa, a utility percentage of 50%, a relative humidity of 50% and a temperature of 85° C. for both of the oxygen electrode and the fuel electrode. The measurement results are shown in Table 3 and FIG. 11(b).

(3) Measurement of Percent Defective

Using a single cell comprising each membrane electrode assembly in EXAMPLES 12-16 and COMPARATIVE EXAMPLES 6 and 7, a He gas at a pressure of 0.5 kPa was supplied to the cell from one side to measure the volume of a He gas passing through the cell to the other side per a unit time, thereby determining the amount of He leaked. By measuring 50 cells for each EXAMPLE and COMPARATIVE EXAMPLE, those in which the amount of He leaked was 0.1 ml/(cm²×minute) or more were counted as defective products. The results are shown in Table 3 and FIG. 11(b).

TABLE 3
Membrane electrode assembly using polymer electrolyte membrane
made of sulfonated polysulfone

| | Q value | Remaining Solvent | Hot-Pressing | | Percent | Generated |
|---|---|---|---|---|---|---|
| No. | (C/cm²) | (wt. %) | First | Second | Defective | Voltage |
| COM. EX. | 0.05 | 25 | 80° C., | — | <1% | 0.60 V |
| 6 | | | 2.5 MPa, | | | |
| | | | 2 min. | | | |
| EXAMPLE | 0.09 | 15 | 150° C., | — | <1% | 0.70 V |
| 12 | | | 2.5 MPa, | | | |
| | | | 2 min. | | | |
| EXAMPLE | 0.11 | 20 | 120° C., | — | <1% | 0.72 V |
| 13 | | | 2.5 MPa, | | | |
| | | | 2 min. | | | |
| EXAMPLE | 0.13 | 10 | 80° C., | 160° C., | <1% | 0.80 V |
| 14 | | | 1.5 MPa, | 2 MPa, | | |
| | | | 2 min. | 1 min. | | |
| EXAMPLE | 0.15 | 10 | 80° C., | 160° C., | <1% | 0.81 V |
| 15 | | | 2.5 MPa, | 2 MPa, | | |
| | | | 2 min. | 1 min. | | |
| EXAMPLE | 0.18 | 5 | 120° C., | — | <1% | 0.80 V |
| 16 | | | 2.5 MPa, | | | |
| | | | 2 min. | | | |
| COM. EX. | 0.21 | 1 | 180° C., | — | 14% | 0.82 V |
| 7 | | | 2.5 MPa, | | | |
| | | | 2 min. | | | |

As is clear from Table 3 and FIG. 11(b), when the membrane electrode assembly has a Q value of less than 0.09 C/cm², voltage generated thereby is low, and when the Q value is more than 0.18 C/cm², the percent defective is extremely high. Accordingly, in the membrane electrode assembly using sulfonated polysulfone as a sulfonated hydrocarbon polymer, the polymer electrolyte membrane should have a Q value of 0.09-0.18 C/cm².

Though the polymer electrolyte membranes made of sulfonated polyetheretherketone or sulfonated polysulfone were used in EXAMPLES 8-16 and COMPARATIVE EXAMPLES 4-7, the same effects as above were obtained as a result of experiment on polymer electrolyte membranes made of other polymers such as sulfonated polyethersulfone, sulfonated polyetherimide, sulfonated polyphenylene sulfide and sulfonated polyphenylene oxide.

As described above in detail, because the first membrane electrode assembly for a polymer electrolyte fuel cell according to the present invention has a structure in which the catalytic layers on both sides project into the polymer electrolyte membrane, it exhibits excellent self-humidifying function. Accordingly, low-humidifying operation can be carried out without sacrificing a power-generating performance in a polymer electrolyte fuel cell constituted by stacking such membrane electrode assemblies via separator plates.

Also, because the second membrane electrode assembly of the present invention comprises a high-softening-point polymer electrolyte membrane having a Q value in a desired range, the polymer electrolyte membrane has such a high heat resistance that it is not decomposed even by hot-pressing at high temperatures.

What is claimed is:

1. A membrane electrode assembly comprising a pair of opposing electrodes each having a catalytic layer, and a polymer electrolyte membrane sandwiched by said electrodes, part of said catalytic layers being projecting into said polymer electrolyte membrane.

2. The membrane electrode assembly according to claim 1, wherein the projection depth of said catalytic layer is 0.5 μm or more and less than 5 μm.

3. The membrane electrode assembly according to claim 1, wherein when there are arbitrary two points, whose linear distance is 10 μm or more, in an interface of said polymer electrolyte membrane with each of said catalytic layers, the distance along said interface is longer than said linear distance by 15% or more on average.

4. The membrane electrode assembly according to claim 1, wherein the DC resistance of said polymer electrolyte membrane in a thickness direction determined by impedance measurement is 90% or less of the DC resistance of a membrane electrode assembly having the same structure except that part of catalytic layers do not project into a polymer electrolyte membrane.

5. A membrane electrode assembly comprising a polymer electrolyte membrane, said polymer electrolyte membrane having a softening point of 120° C. or more and a Q value of 0.09-0.18 C/cm².

6. The membrane electrode assembly according to claim 5, wherein said membrane electrode assembly has a structure in which said polymer electrolyte membrane is sandwiched by a pair of opposing electrodes each having a catalytic layer, part of said catalytic layers projecting into said polymer electrolyte membrane.

7. The membrane electrode assembly according to claim 6, wherein the projection depth of said catalytic layers into said polymer electrolyte membrane is 0.5 μm or more and less than 5 μm.

8. The membrane electrode assembly according to claim 6, wherein when there are arbitrary two points, whose linear distance is 10 μm or more, in an interface of said polymer electrolyte membrane with each of said catalytic layers, the distance along said interface is longer than said linear distance by 15% or more on average.

9. The membrane electrode assembly according to claim 6, wherein the DC resistance of said polymer electrolyte membrane in a thickness direction determined by impedance measurement is 90% or less of the DC resistance of a membrane electrode assembly having the same structure except that part of catalytic layers do not project into a polymer electrolyte membrane.

10. The membrane electrode assembly according to claim 1 or 5, wherein said polymer electrolyte membrane is made of a sulfonated hydrocarbon polymer that may contain oxygen in its skeleton or other substituent groups than a sulfonic group.

11. The membrane electrode assembly according to claim 10, wherein said sulfonated hydrocarbon polymer is selected from the group consisting of sulfonated polyetheretherketone, sulfonated polysulfone, sulfonated polyethersulfone, sulfonated polyetherimide, sulfonated polyphenylene sulfide and sulfonated polyphenylene oxide.

12. The polymer electrolyte fuel cell constituted by stacking a plurality of said membrane electrode assemblies according to claim 1 or 5 via separator plates.

13. A method for producing a membrane electrode assembly by bonding catalytic layers of a pair of opposing electrodes to both surfaces of a polymer electrolyte membrane, comprising the steps of (1) coating a catalytic layer of one electrode with a solution of a polymer electrolyte in an organic solvent, (2) coating the resultant polymer electrolyte membrane with a catalyst slurry for the other electrode, while the amount of said organic solvent remaining in said polymer electrolyte membrane is 5-20 weight % based on said polymer electrolyte membrane, and (3) after drying, hot-pressing said polymer electrolyte membrane and said electrodes formed on both sides of said membrane.

14. A method for producing a membrane electrode assembly comprising a polymer electrolyte membrane having a softening point of 120° C. or higher and a Q value of 0.09-0.18 C/cm², comprising the steps of (1) forming said polymer electrolyte membrane from a solution of said polymer electrolyte, (2) hot-pressing said polymer electrolyte membrane and a pair of electrodes arranged on both sides of said membrane, while the amount of said organic solvent remaining in said polymer electrolyte membrane is 3-20 weight % based on said polymer electrolyte membrane, and then (3) drying said polymer electrolyte membrane.

15. The method for producing a membrane electrode assembly according to claim 14, wherein said organic solvent is N-methylpyrrolidone.
